(19) United States
(12) Patent Application Publication
(10) Pub. No.: US 2007/0003754 A1
(43) Pub. Date: Jan. 4, 2007

(54) Antistatic composition and part holder

(76) Inventors: Yukihisa Okada, Kanagawa (JP); Toshikazu Numaguchi, Kanagawa (JP)

Correspondence Address: 3M INNOVATIVE PROPERTIES COMPANY, PO BOX 33427, ST. PAUL, MN, 55133-3427, US

(21) Appl. No.: 10/546,515

(22) PCT Filed: Mar. 3, 2004
(86) PCT No.: PCT/US04/06924

§ 371 Date: Jun. 27, 2006

(30) Foreign Application Priority Data
Mar. 6, 2003 (JP) 2003-060136

(51) Int. Cl. B32B 27/18; C08K 3/04

(52) U.S. Cl. 428/323; 428/411.1; 524/495

(57) ABSTRACT

An antistatic composition containing a heat-resistant resin binder with a softening temperature (Ts) of 160-410° C. and carbon blacks and/or carbon nanofibers added as an antistatic agent to the binder is spread on a base material, such as the holding part of a holder such as tweezers, and is heat-treated at a temperature of 200-450° C., so that a film is formed. This film has a surface resistance value of preferably 10³-10¹⁰ Ω/sq.

### TECHNICAL FIELD OF THE INVENTION

The present invention pertains to an antistatic composition, an antistatic film, and a part holder such as tweezers, in which the antistatic film is installed.

Tweezers have been used to handle small objects, temperature-controlled objects, or substances that cannot have direct contact with the hands in terms of the contamination risk and human safety. In particular, when small electronic components are held, the tweezers are an essential tool.

Such tweezers are made from a metallic material such as SUS304, SUS430, and titanium to obtain a spring characteristic, and tweezers suitable for different functions and usage environments are known. However, since tweezers made of a metallic material have a high electrical conductivity, when electronic components are handled, electrostatic discharge at the tip of the tweezers is caused by the electrification of the electronic components or the human body, so that the electronic components are damaged.

In order to solve this problem, controlling the volume resistivity to the range of 10²-10⁶ Ω·cm by installing a titania ceramic or silicon carbide ceramic or by coating the silicon carbide using the CVD method has been proposed (for example, see patent reference 1).

(Patent Reference 1)

Japanese Kokoku Utility Model No. Hei 5[1993]-2303 (pages 1-2)

However, the proposed ceramic tip is easily broken or cracked by the user applying force or colliding with other objects. An exchangeable structure is sometimes adopted in the tip part, which is easily cracked; however, during the exchange, the tip part is damaged by unnecessary force when fixing it with screws or by inserting the tip part. Furthermore, the damage to electronic components due to the discharge of static electricity, etc., cannot be avoided by making the volume resistance or surface resistance of the tweezers uniform. For these reasons, it is necessary to prepare tweezers having a resistance value suitable for a device being held, and it is difficult to control the resistance value by installing a ceramic tip.

On the other hand, coating using the CVD method is a process that can overcome the drawback of the easily fractured ceramics; however, in coating using the CVD method, the cost in obtaining a practical coating film thickness is high. Also, there are tweezers in which a fluororesin is coated or to which electrical conductivity is provided. However, their main purpose is to prevent damage to the objects being held. They are electrified by an insulator; even if the electrical conductivity is provided, since the electrical conductivity is too high, although the static electricity is not stored in the tweezers, when the tweezers makes contact with an electronic device in which the static electricity is stored, the electronic device is damaged by the current introduced into the tweezers from the electronic device.

The purpose of the present invention is to provide an antistatic composition and an antistatic film for providing chargeability to a part for holding electronic components such as IC chips and a parts holder such as tweezers on which the antistatic film is applied.

In order to solve the problems, the present invention provides an antistatic composition containing a heat-resistant resin binder with a softening temperature (Ts) of 160-410° C. and carbon blacks and/or carbon nanofibers added as an antistatic agent to the binder.

Also, the present invention provides an antistatic film formed by spreading the above-mentioned antistatic composition on a base material and heat-treating the composition at a temperature of 200-450° C.

Furthermore, the present invention provides a part holder having the above-mentioned antistatic film in the holding part.

A desired surface resistance value of 10³-10¹⁰ Ω/sq at about room temperature can be achieved by coating the antistatic composition of the present invention containing a heat-resistant resin binder and carbon blacks and/or carbon nanofibers as an antistatic agent on at least the holding part of a holder such as tweezers. Also, the coated film is formed by a heat treatment at a temperature of 200° C. or higher, with a network of carbon blacks and/or carbon nanotubes dispersed as an antistatic agent in the film being re-formed, so that electrical conductivity, which cannot be obtained by a low-temperature drying, cannot be realized.

Embodiment of the Invention

The antistatic composition is characterized by including a heat-resistant resin binder with a softening temperature (Ts) of 160-410° C. and carbon blacks and/or carbon nanofibers as an antistatic agent added to the binder.

As examples of a heat-resistant resin binder with a softening temperature (Ts) of 160-410° C., fluororesin compounds such as polytetrafluoroethylene or tetrafluoroethylene-perfluoroalkyl vinyl ether copolymer, polyimide, or a mixture of two or more of these compounds can be mentioned.

As examples of carbon blacks used as an antistatic agent, various types such as furnace black, channel black, gas black, acetylene black, and arc black can be used. It is preferable for the carbon blacks to have an average particle diameter of 20-60 nm and to have a high electrical conductivity and good dispersibility; as products on the market, for example, Toca Black #3855, #5500, #4500, #4400, #4300, etc., can be used.

“Carbon nanofibers” in this specification mean hollow ring-shaped fibers, the so-called carbon nanotubes, solid fibers, and layered fibers, the so-called graphite nanofibers. Also, carbon filaments and carbon fibrils can be used as the carbon fibers.

It is preferable for the carbon nanofibers used as an antistatic agent in the present invention to have a diameter of 80-200 nm and an aspect ratio of 100-500. A product on the market, VGCF made by Showa Denko K.K., can be used.

The carbon blacks or carbon nanofibers may be used alone or in combinations as the antistatic agent. When they are used alone, the amount of carbon blacks added to the binder is preferably 20-70 vol %, more preferably 40-60 vol %, and the amount of carbon fibers added is preferably 1-15 vol %, more preferably 2-8 vol %. When the carbon blacks and the carbon nanofibers are used together, as the amount added, the carbon blacks are preferably added at 20-70 vol % to the binder, and the carbon nanofibers are preferably added at 0.1-30 wt % to the carbon black. More preferably, the carbon blacks are added at 30-60 vol % to the binder, and the carbon nanofibers are added at 0.5-15 wt %.

The antistatic composition of the present invention is obtained by mixing the above-mentioned binder and carbon blacks and/or carbon nanofibers. In the antistatic composition of the present invention, if necessary, other components such as colorants, dispersants, stabilizers, antioxidants, flame retardants, lubricants, fillers, and tackifiers may be added in addition to the binder and the carbon blacks and/or carbon nanofibers.

Also, the present invention provides an antistatic film formed from the above- mentioned antistatic composition. First, the antistatic film is dissolved or dispersed in a solvent such as n-methylpyrrolidone. At that time, dispersants for dispersing the carbon blacks, surfactants for improving the wettability of the base material, and defoaming agents for suppressing foam formation may also be added.

Next, the solution or dispersed solution of the above-mentioned antistatic composition is spread on the surface of the desired base material by ordinary spreading methods such as the spray method, bar coating method, doctor blade method, and dipping method, and the solvent is removed by heating, so that a film is formed. Although the amount being spread is not particularly limited, in order to obtain sufficient characteristics such as antistatic characteristics and hardness, the solid fraction is preferably 50-1,000 g/m², and the film thickness is preferably 200 μm or less, more preferably 10-50 μm. In order to remove the solvent, the heating temperature is usually 50° C. or higher; however, the solvent is heated at 200-450° C. for 30 min in the present invention. A network of the dispersed carbon blacks and/or carbon nanofibers is formed in the film by heating at such a high temperature, and a high antistatic characteristic, which cannot be obtained by a low-temperature drying, can be achieved. Preferably, a surface resistance value of preferably 10³-10¹⁰ Ωsq, more preferably 10⁶-10⁸ Ω/sq, at about room temperature can be reached. In this specification, the surface resistance value is that measured by the MCP-HT260 [process] of Mitsubishi Petrochemical Co., Ltd. (currently, Mitsubishi Chemical Industries Ltd.).

The base material for forming the antistatic film is not particularly limited, and articles in which the antistatic characteristic is desired may be adopted. It is preferably the holding part of a holder such as tweezers used in holding electronic components. FIG. 1 is an oblique view showing tweezers 1 made of SUS on which the antistatic film of the present invention is formed. In the tweezers 1, the above-mentioned film is formed at a thickness of 10-100 μm on the inner side surface 2 of the tweezers made of a metal such as titanium by the spraying method, etc.; however, it is essential to form it at least at a tip 3 for holding a component. With the formation of such a film, a surface resistance value of 10³-10¹⁰ Ω/sq, preferably 10⁶-10⁸ Ω/sq, can be reached, so that the damage of electronic components due to electrostatic discharge at the tweezers tip can be prevented. Furthermore, the film exhibits the mechanical strength of the carbon blacks and/or the carbon nanofibers dispersed in it, and exhibits a markedly high strength by the network; the film can thus be completely formed at the tweezers tip at about 100 μm, and its separation is difficult.

In the present invention, the reason why the resin binder with a softening temperature of 160-410° C. is used is that it is necessary to utilize the dynamic percolation phenomenon generated in a high-temperature treatment to achieve the desired electrical conductivity by a low amount of filler being mixed. The dynamic percolation phenomenon is a phenomenon in which the electrical conductivity is raised by heating the resin binder to a high temperature (for example, a temperature 100° C. higher than the softening temperature) so that it attains “dynamic activity” even with the amount of the mixture being lower than the percolation threshold, although the electrical conductivity is rapidly raised at a certain amount of mixture in an ordinary composite material through the sudden formation of an electroconductive path by mixing an electroconductive filler into the resin binder (percolation threshold). Therefore, if the softening temperature is low, the resin binder cannot withstand a high heat treatment during the film formation, so that it is melted and separated or thermally degraded, thereby being unable to be used. On the other hand, in the resin with a softening temperature that is too high, a solution or dispersed solution is difficult to be prepared. Thus, in consideration of the characteristics of the existing high-molecular-weight materials, it is appropriate to set 410° C. as the upper limit.

It is preferable for the resin binder with a softening temperature of 160-410° C. to have a glass transition temperature of 150-400° C., if it is measurable. Also, the softening temperature and the glass transition temperature are respectively measured by a thermomechanical characteristic activity (TMA) differential scanning calorimeter (DSC) made by Rigaku K.K. Here, the softening point and the glass transition temperature were determined by the onset temperature of the temperature profiles obtained.

### APPLICATION EXAMPLES

### Application Example 1

Carbon blacks with a primary particle diameter of 25 nm (Toka Black #5500 made by Tokai Carbon Co., Ltd.) at 30 parts by weight and carbon nanofibers with an average diameter of 150 nm and an aspect ratio of 100 or more (VGCF made by Showa Denko K.K.) at 3 parts by weight were well mixed with a polytetrafluoroethylene (softening temperature of 327° C.) dispersed solution (solid fraction of 30 wt %) at 100 parts by weight. On the other hand, the body surface of tweezers made of SUS304 as a base material was plasma-treated with a #200 treating material. After the plasma treatment, the above-mentioned dispersed solution was coated at a dry film thickness, on average, of about 30 gm by the spraying method. It was initially dried at 100° C. for 10 min and annealed at 300° C. for 30 min, so that tweezers on which a film was formed was obtained.

### Application Example 2

Similarly to Application Example 1 except for not using the carbon blacks and mixing only the carbon nanofibers at 5 parts by weight with the tetrafluoroethylene dispersed solution (30 wt % solid fraction in water) at 100 parts by weight, tweezers on which a film was formed was obtained.

### Comparative Example 1

An electroconductive coat prepared by mixing 60 wt % nickel particles (average particle diameter of 100 nm) in a vinyl chloride (softening temperature of 120° C.) binder was coated at a dry film thickness, on average, of about 100 μm on the main body of the above-mentioned plasma-treated tweezers by the dipping method. It was dried at 70° C. for 30 min, so that tweezers on which a film was formed was obtained.

### Comparative Example 2

Similarly to Application Example 1 except for setting the drying temperature to 100° C. and heating and drying for 1 h, tweezers on which a film was formed was obtained.

Performance Evaluation

For the above-mentioned application examples and comparative example, using tweezers made of a ceramic on the market on which no film was installed, the following tests were carried out.

1. Electrical Conductivity Measurement

The film surface was evaluated at room temperature (20° C.) by the four-terminal method, and its surface resistance was measured.

2. Surface Hardness Measurement

The film surface hardness (Hv) was evaluated by the pencil hardness method (JIS K5400).

3. Solvent Resistance Test

The tweezers were immersed for 12 h into distilled water, methyl alcohol, isopropyl alcohol, methyl ethyl ketone, and tetrahydrofuran, then the solvent resistance was measured.

4. Impact Resistance Test

When the tweezers were freely dropped into a stainless steel plate with a thickness of 5 mm from a height of 10 cm, cracks of the tweezers were observed.

The above-mentioned results are shown in the following table.

TABLE I

| | Surface | | | Impact |
|---|---|---|---|---|
| | resistance | Pencil | Solvent | resistance |
| | (Ω/sq) | hardness | resistance test | test |
| Application | 5.2 × 10⁶ | 2 H | No change | No change |
| Example 1 | | | | |
| Application | 4.5 × 10⁶ | 3 H | No change | No change |
| Example 2 | | | | |
| Application | 4.7 × 10⁶ | 2 H | No change | No change |
| Example 3 | | | | |
| Comparative | 6.3 × 10⁷ (#1) | 2 B | Separation (#2) | No change |
| Example 1 | | | | |
| Comparative | 9.3 × 10¹⁰ | 1 H | No change | No change |
| Example 2 | | | | |
| Product on | 5.3 × 10⁶ | 6 H | No change | Crushed (#3) |
| the market | | | | |

(#1) A part that could not be coated was generated at the tip.
(#2) The solvent was turbid in methyl ethyl ketone and tetrahydrofuran, and the film was dissolved.
(#3) The tip was partially dropped or folded from the base of the ceramic part.

In the composition of the present invention containing the heat-resistant resin such as tetrafluoroethylene as a binder, in particular, the corners and the tips of tweezers, which were difficult to be formed from a composition containing other binders such as vinyl chloride, could be completely coated. Also, in the film formed from the composition in which the carbon nanofibers, etc., are dispersed into the heat-resistant resin binder of the present invention, not only was the internal stress during the film formation very small, but the corners or the tips of the tweezers could be favorably coated due to the network effect of the carbon nanofibers, etc. Furthermore, in the film formation of the present invention, the electrical conductivity of the film could be much more raised by a high heat-treatment temperature. In Comparative Example 2, the surface resistance value at room temperature is 10¹⁰ Ω, whereas in Application Example 1 prepared with the same composition, the surface resistance value is 10⁶ Ω, so that a marked electrical conductivity improvement is realized. This is considered to be due to the dynamic percolation effect of the carbon nanofibers, etc., dispersed into the film.

Also, the existence of a separation of the film at the tweezers tip can be easily identified by the following method.

In other words, as shown in FIG. 2a, cotton 4 dyed with an electroconductive solution such as an alcohol and salt water was inserted into the tip 3 of the tweezers 1 on which the film was coated, with a circuit being formed between the tip and a part on which the film was not formed in the tweezers 1, that is, a metal exposure part. It corresponds to an equivalent circuit as shown in FIG. 2b, When there is no separation of the film of the tip 3, since the resistance R₁ is 10⁶ or more and another resistance R₂ is about 10^{31 1}, R₁>>R₂. On the other hand, if the film of the tip 3 is separated, R₁ is almost equal to R₂. In the equivalent circuit of FIG. 2b, since I=V/(R₁+R₂), I is greatly changed by the separation of the film, so that the separation can be easily detected.

With the use of the composition of the present invention, a film with high antistatic characteristics and excellent hardness, impact resistance, and solvent resistance can be formed.

### BRIEF DESCRIPTION OF THE FIGURES

FIG. 1 is an oblique view showing tweezers on which the film of the present invention is coated.

FIGS. 2a and 2b illustrate a method for easily determining the separation of the film.

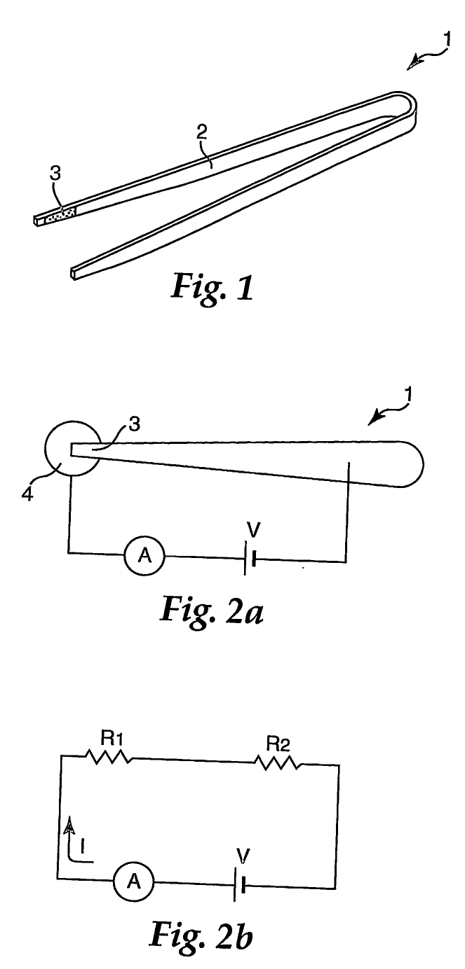

### EXPLANATION OF NUMERALS

| | |
|---|---|
| 1 | Tweezers |
| 2 | Main body |
| 3 | Holding part |
| 4 | Cotton impregnated with an electroconductive solution |

What is claimed is

1. An antistatic composition, characterized by including a heat-resistant resin binder with a softening temperature (Ts) of 160-410° C. and at least one of carbon blacks and carbon nanofibers added as an antistatic agent to the binder.

2. An antistatic film, characterized by being formed by spreading the antistatic composition of claim 1 on a base material and heat-treating the compostition at a temperature of 200-450° C.

3. A part holder, characterized by having the antistatic film of claim 2 in the holding part.
